(19) United States
(12) Patent Application Publication
(10) Pub. No.: US 2015/0337794 A1
(43) Pub. Date: Nov. 26, 2015

(54) Turbine with helical blades

(71) Applicant: Yvan Perrenoud, Lombok Barat (ID)

(72) Inventor: Yvan Perrenoud, Lombok Barat (ID)

(21) Appl. No.: 14/758,843

(22) PCT Filed: Jan. 4, 2013
(86) PCT No.: PCT/IB2013/000011

§ 371 Date: Jul. 1, 2015

(51) Int. Cl. F03B 13/10; F03D 3/06; F03D 3/00; F03D 9/00; F03B 17/06; F03B 3/12

(52) U.S. Cl. CPC F03B 13/10; F03B 17/061; F03B 3/121; F03D 3/005; F03D 9/002; F03D 3/062

(57) ABSTRACT

The invention relates to a turbine for generating electricity from a fluid current, comprising: a central bulb (2); first and second groups of blades each mounted on the bulb (2); the first group of blades being arranged to rotate in a first direction under the action of the current, and the second group of blades being arranged to rotate in a second direction opposite the first under the action of the current, the blades of said second group also being arranged to rotate in the space delimited by the blades of the first group. The first and second groups each comprise at least two helical blades (42, 52) and at least two maintaining blades (41, 51). In each of the first and second groups, the number of helical blades (42, 52) is equal to the number of maintaining blades (41, 51): the bases (41a, 51a) of the maintaining blades (41, 51) are fastened to the bulb (2) and extend essentially perpendicularly relative to the bulb (2). Each helical blade (42, 52) is fastened at a first end (42a, 52a) to the front end (2a) of the bulb (2), and at or near a second end (42b, 52b) to the apex (41b, 51b) of a maintaining blade (41, 51).

The present invention relates to a turbine with helical blades for producing electricity.

Hydraulic energy is a so-called form of “green” or “renewable” energy. To date, man has created dams and forced ducts in order to generate a minimum current to cause a turbine to rotate, and thus produce electricity. However, rivers, streams and certain expanses of natural water (sea or ocean) may have currents or volumes of water that may make it possible to rotate a turbine and thus produce electricity. The use of these rivers, streams or natural waterways requires little infrastructure, since the aim is to use the natural current and not to create one. However, the turbines used must be adapted to the specific conditions and must have a low impact on the environment in which they are installed.

Document WO 2007/129049 describes a turbine comprising a first rotor mounted rotatingly around an axis of rotation extending transversely relative to the direction of the current and having a plurality of blades, preferably helical blades, and the longitudinal axis of which is also transverse to the direction of the current. The turbine also comprises a second rotor mounted rotatingly around the axis of rotation and having a plurality of blades, preferably helical blades, and the longitudinal axis of which is also transverse with respect to the direction of the current. The first rotor is arranged to rotate in a first direction under the action of the current and the second rotor is arranged to rotate in a second direction opposite the first. The blades of the second rotor are arranged such that the blades of the first rotor rotate within the space delimited by the blades of the second rotor.

This turbine must be positioned such that its longitudinal axis is transverse with respect to the current. Yet, a turbine placed transversely with respect to the current generates considerable turbulences. Furthermore, it is necessary for a turbine placed transversely with respect to the current not only to have a significant current, but also a rapid discharge of the fluid downstream, i.e., a sufficient slope of the fluid conduit to recreate the necessary current therein. In the case of a transverse position of the turbine, its blades are efficient particularly when they perform their half-circle, seen in profile, in the direction of the current. When they perform their second half-circle, rising back up the current, they are less performing irrespective of the shape of their profile because they are working in a stream disturbed by the blades situated upstream and which precede them relative to the direction of rotation. This turbine may be kept on the surface of the stream, half submerged. In this position, the performance of the turbine is reduced by the disturbances of the stream situated near its surface and the blades only work over half of their complete rotation.

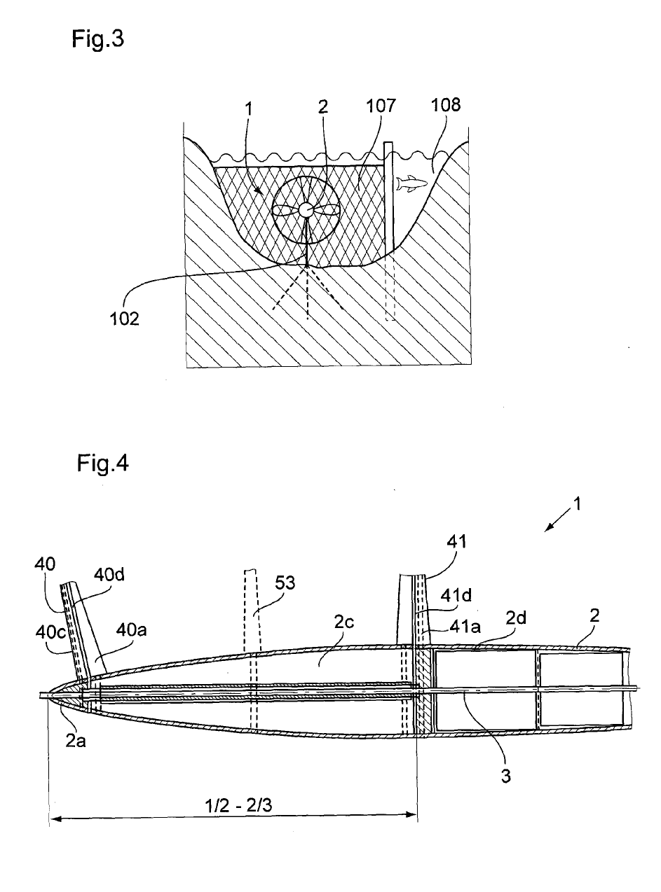

The transverse position of such a turbine further implies a significant concrete infrastructure channeling the entire stream between the fastening points of the helical blades at their ends. Spaces left between the rotating bases of the blades (rotors) and the sides of the channel would reduce the productivity of the turbine. The turbine described by WO 2007/129049 cannot be positioned parallel to the current because the bases of the helical blades (rotors) are flat. Their entire surface would then be found positioned transversely relative to the current. Even truncated further and further toward the outside, between the fastening points with the helical blades (FIGS. 2 and 3 of WO 2007/129049), the bases would cause major turbulences of the stream downstream from their positions and would reduce the productivity of the turbine to very little.

The aim of the present invention is to produce a turbine making it possible to produce electricity in a nonpolluting manner, that is effective in small, medium or strong currents and that only requires very little infrastructure having only a minimal impact on the environment, in particular on the flora and fauna, and on human activity.

The present invention relates to a turbine according to claim 1.

The drawings diagrammatically and illustratively show several embodiments of the instrument according to the invention.

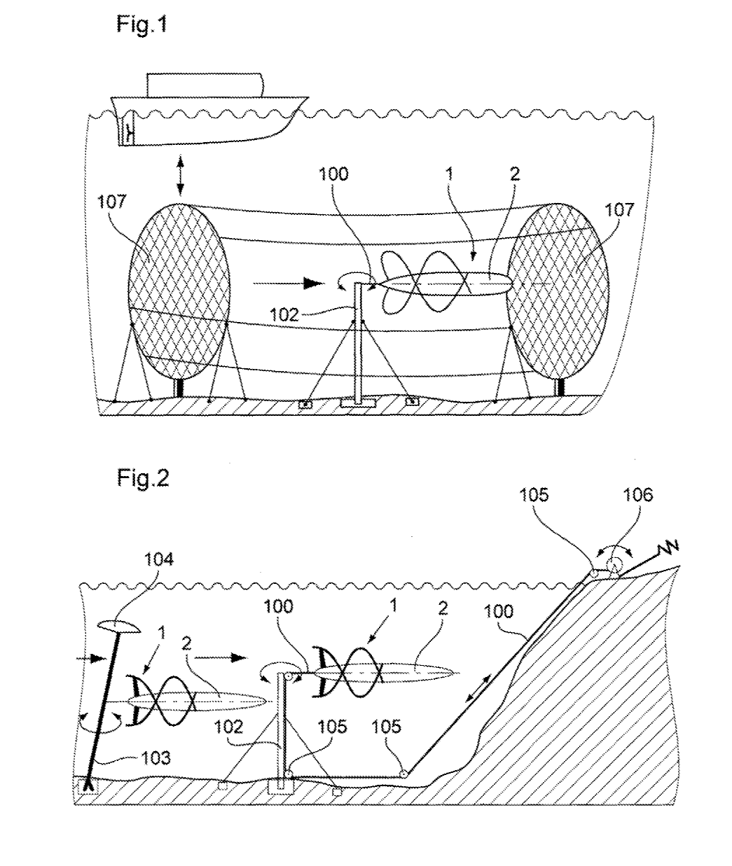

FIGS. 1 and 2 are side views of a turbine according to the invention submerged in the sea.

FIG. 3 is a front view of a turbine according to the invention situated in a river or stream.

FIG. 4 is a partial sectional view along its longitudinal axis of the turbine according to the invention in its version for a weak or medium current.

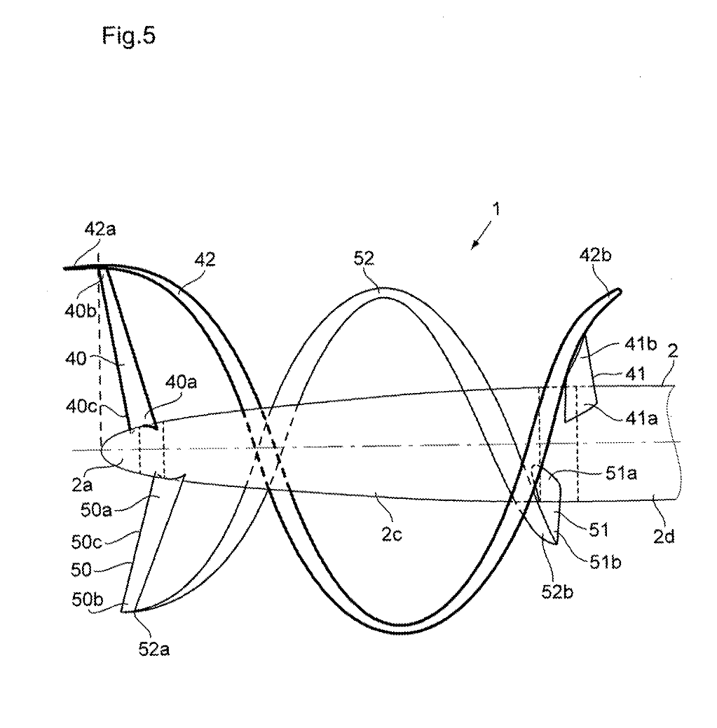

FIG. 5 is a side view of part of the blades of a turbine according to the invention in its version for a weak or medium current.

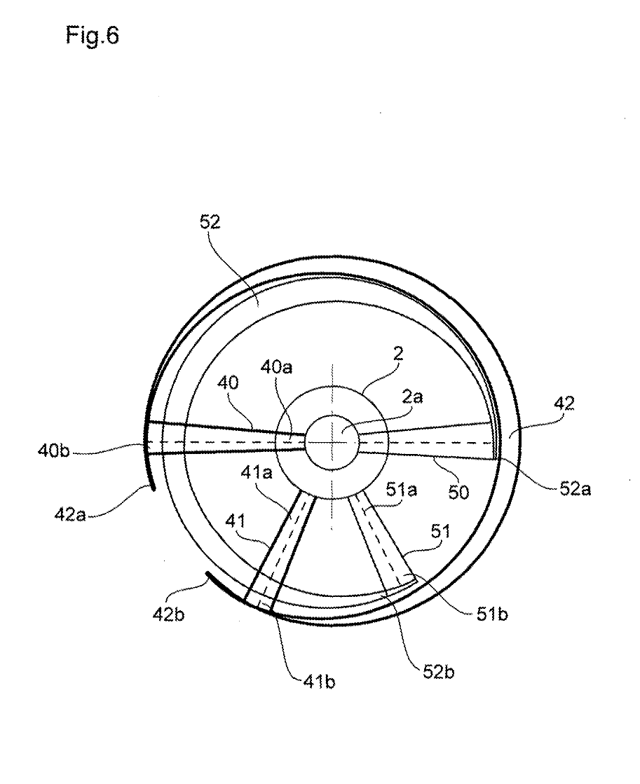

FIG. 6 is a front view of the blades illustrated in FIG. 5.

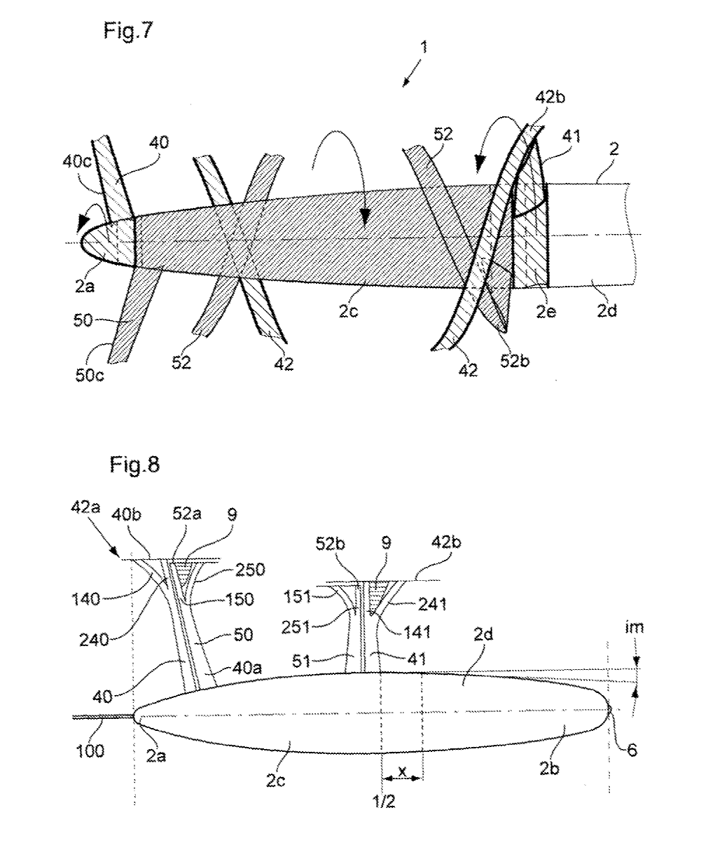

FIG. 7 is a view similar to FIG. 5 illustrating the directions of rotation of the first and second groups of blades secured to a turbine according to the invention in its version for a weak or medium current.

FIG. 8 is a side view of the bulb of the turbine according to the invention in its version for a weak or medium current.

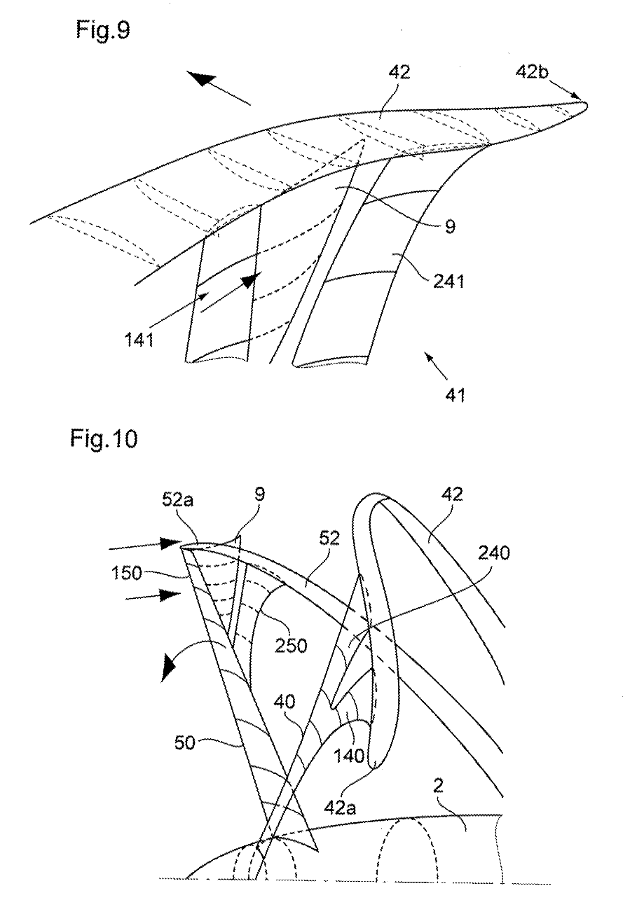

FIGS. 9 and 10 illustrate an alternative in which semi-rigid wings are fastened respectively on the outer maintaining blades and the inner regulating blades to start up the first and second groups of blades of the turbine according to the invention.

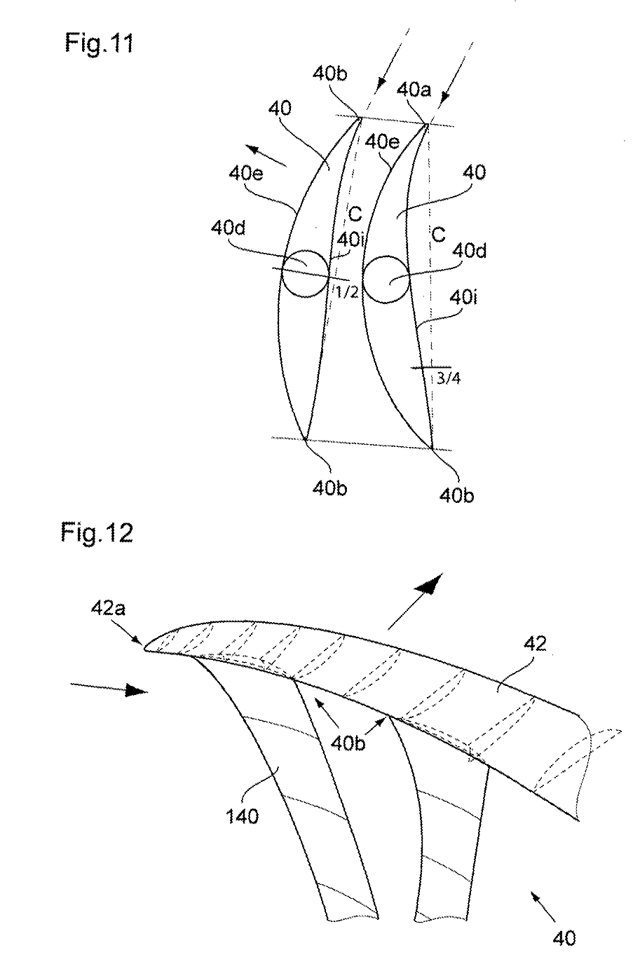

FIG. 11 illustrates the profile of all of the blades of the turbine according to the invention.

FIG. 12 is a detailed view of the apex of a regulating blade and the front end of a helical blade of a turbine according to the invention in its version for a weak or medium current.

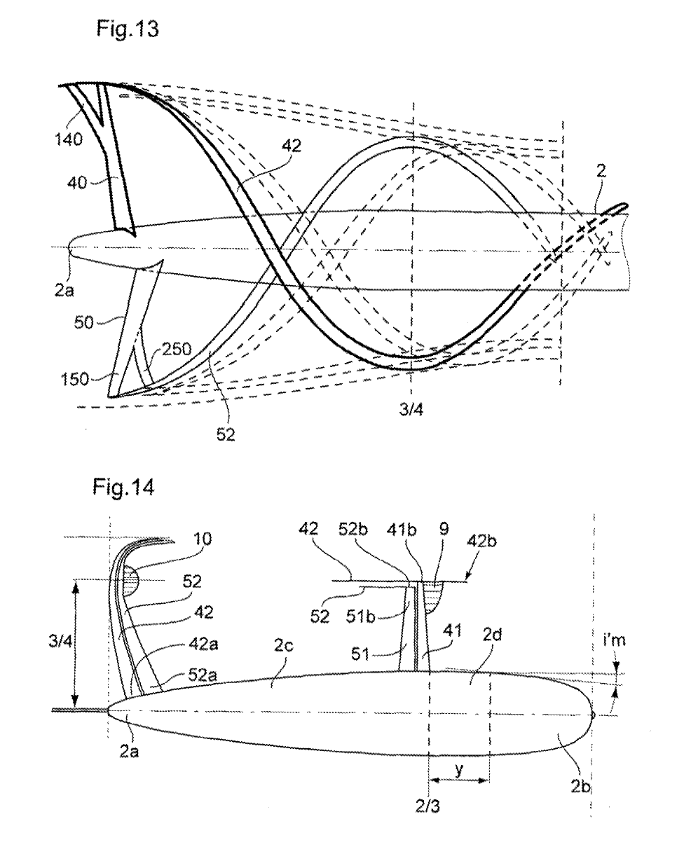

FIG. 13 illustrates the spirals described by the outer and inner helical blades of the turbine according to the invention.

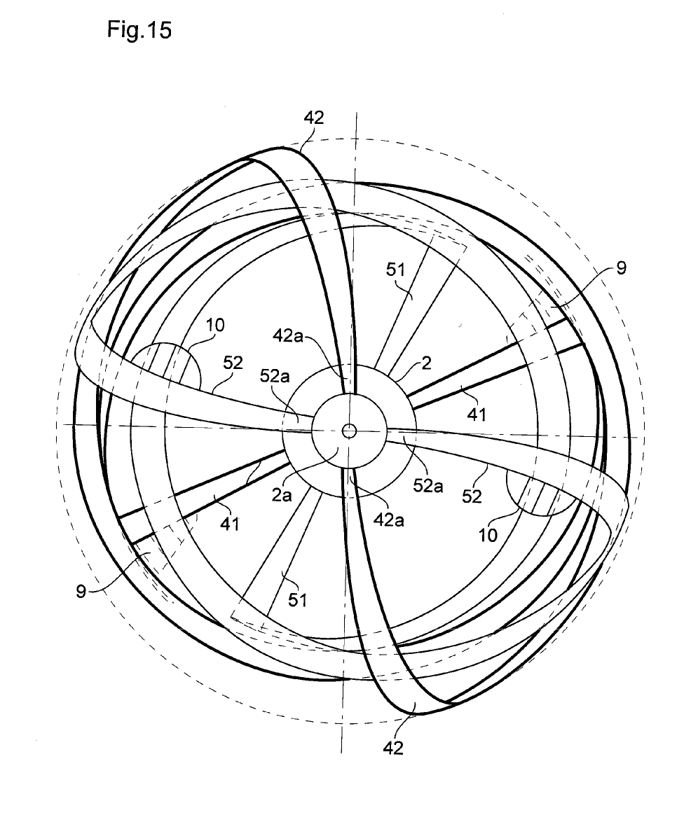

FIG. 14 is a side view of the bulb of the turbine according to the invention in its version for a strong current.

FIG. 15 is a front view of the turbine according to the invention in its version for a strong current.

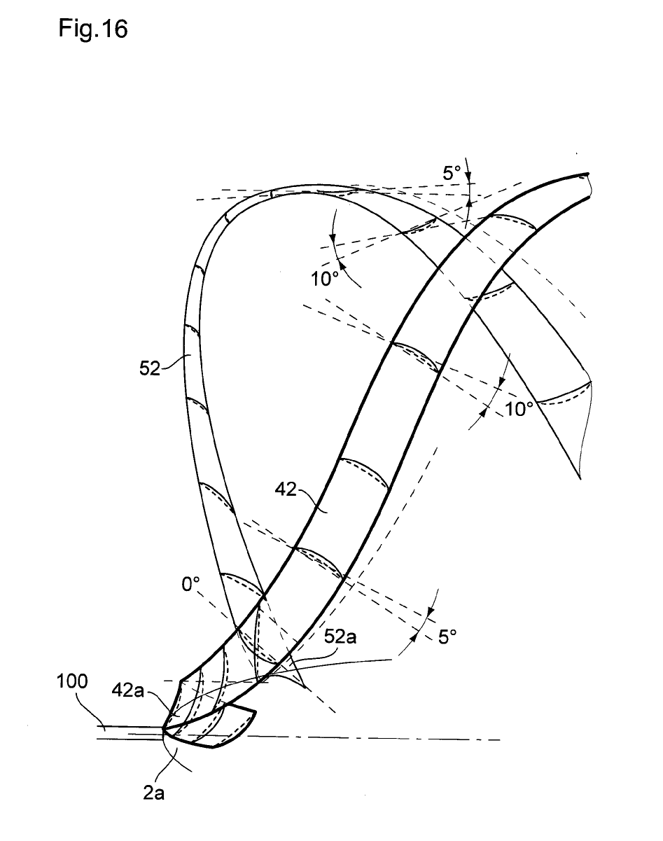

FIG. 16 is a detailed view, in planar or side view, of the front of the helical blades of the turbine according to the invention in its version for a strong current, representing the relative incidence angles of the helical blades.

The turbine according to this invention may operate in a channeled liquid fluid and in a free or channeled gaseous fluid. In the open air, it is placed in a windy area, in most cases at a certain distance from the Earth's surface to be able to benefit from as winds that are as consistent as possible, in terms of direction and intensity. It requires a more significant infrastructure than the turbine operating in open water. The turbine operating in open air may pivot by 360° on the horizontal plane in both directions, around an axis situated in front, at the maximum separation of the helical blades with respect to the bulb. Whether it is operating in a channeled fluid or a free gaseous stream, this turbine is provided with at least two front and rear circular structures developed essentially perpendicular to and around the bulb outside the helical blades, to which the helical blades are fastened, respectively at their maximum separation with respect to the bulb and at a level situated on the back half of the length of the bulb. The outside of the circular structures, over their entire circumference, is secured to a proportionate number of maintaining rings of the turbine situated around the structures, via ball bearings.

The turbine according to the invention has a configuration of blades (groups of helical and maintaining blades or groups of regulating, helical and maintaining blades developed around the bulb) that also allows it to be propulsive, subject to the inversion of the concave and convex sides and the curvature of the profiles of the regulating blades, and those of the helical blades up to approximately ⅔ to ¾ of their length considered from their maximum separation with respect to the bulb, and the inversion of the transverse and longitudinal incidences of said helical blades on that fraction. According to the invention, the contraction, then the longitudinal expansion of the helical blades are also reversed: these blades extend longitudinally more and more, then less and less over approximately ⅔ to ¾ of their length considered from their maximum separation with respect to the bulb. Over this fraction, their transverse incidence increases more and more. At approximately between ⅔ and ¾ of their length, the longitudinal and transverse incidences of the helical blades reverse, as do the convex and concave sides and the curvature of their profile. From that so-called propulsive level, the helical blades are propelled more and more, up to their rear end, by a fuel or preferably by the injection of hydrogen into the piping. The maintaining blades according to the invention are similar in this embodiment. The inner helical blades according to the invention are fixed in this embodiment to the apex of additional maintaining blades, at least one group, developed essentially perpendicular to the bulb and situated on the rear half of the length of the bulb. These so-called additional blades have no relative incidence: their role is furthermore to separate the propulsive and propelled parts of the turbine of the reactor.

The turbine operating in the sea and in rivers and streams, the flow rate of which is in principle not less than a known minimum, has better productivity, instantaneous and annual, than a wind turbine. The water currents due to tides are known, and they vary little in terms of intensity and direction. There are many sites where slack water is short-lasting. To offset the lack of production during slack water times, a fraction of electricity produced by the turbine may be used to power a pump that propels water into a reservoir situated at an altitude. During slack water periods, a turbine produces electricity using the water from the reservoir.

The turbine 1 according to the invention generally has a bulb 2 on which a series of blades is fastened designed to rotate under the force of the current. These bulbs will be described in detail below.

We will begin by briefly describing the anchoring of the turbine 1 and its connection.

In general, the turbine 1 is designed to be placed essentially parallel to the current and is placed so as not to interfere with the environment surrounding it, in particular the fauna and flora, or human activity. For example, at sea, the turbine 1 will be anchored at a sufficient depth not to hinder maritime traffic (FIG. 1). Special developments can also be provided to protect the fauna, the flora, and divers such as the nets 107 illustrated in FIGS. 1 and 3. In rivers and streams, the turbine 1 could for example be placed parallel to a fish-way 108 to thus limit the impact on the surrounding fauna and flora (FIG. 3).

The turbine 1 is maintained upstream by a maintaining cable or maintaining tube 100 inside which an electric cable is found. In the sea as illustrated in FIGS. 1 and 2, the maintaining cable 100 and the turbine 1 can pivot by 360° in a horizontal plane in both directions to remain parallel to the current. At sea, the cable 100 is maintained at the apex of an anchored profiled mast 102 anchored in the bottom as illustrated in the right part of FIG. 2 or along a pivoting profiled tube 103, the base of which is anchored in the bottom and the apex of which is maintained by a profiled submerged buoy 104 as illustrated in the left part of FIG. 2.

In rivers and streams, as illustrated in FIG. 3, the maintaining tube or cable 100 is fastened to a profiled mast 102 anchored in the bottom.

At sea and as illustrated in FIG. 2, the maintaining cable 100 extends inside the profiled mast 102 or the profiled tube 103, to reach the closest bank via pulleys 105. On the bank, a capstan 106 makes it possible to empty or wind the maintaining cable 100, to control the rise of the turbine 1 at the surface and return it to the operational position. In order to trigger the upward movement of the turbine, the action of two divers is sufficient to a depth of approximately forty meters. At a greater depth, a buoy may be fastened to a ring 6 situated at the rear end 2b of the bulb 2, inflated, then gradually deflated. In order to control the upward movement of the turbine from the surface, a cord is passed in a loop in the ring 6. When it is lowered, to prevent the turbine 1 from being lowered too quickly, a cord is passed in a loop in the ring 6 and gradually emptied from the surface.

In general, the maintaining cable or tube 100 is fastened to the front end of the hub 3 of the turbine 1. The turbulences due to the tube 103 or the profiled mast 102 are not very significant along their trailing edge, and the stream is not slowed in front of the turbine in light of the distance that separates them (length of the maintaining tube or cable 100).

The hub 3 is located at the longitudinal center of the bulb 2 of the turbine of the longitudinal axis of said bulb 2 (FIG. 4). In particular, the turbine 1 is positioned such that said means 3 is essentially parallel to the current.

We will now describe, in reference to FIGS. 4 to 13, a first embodiment of the turbine according to the invention whereof the blades are sized for weak to medium currents of approximately 0.5 to 2 m/s. If the stream is stable in terms of intensity and direction, the turbine can operate in a current of more than 2 m/s.

In reference to FIGS. 5 and 6 in particular, the turbine 1 is provided with a first group of secured blades comprising:
at least two outer regulating blades 40 developed essentially perpendicular to the surface of the bulb 2 and the bases 40a of which are situated near the front end 2a of the bulb 2;
at least two outer maintaining blades 41 developed essentially perpendicular to the bulb 2 and situated approximately at the midpoint of the bulb 2; and
at least two outer helical blades 42 each forming approximately ¾ to ⅚ of a turn depending on the dimensions of the turbine and the weight of the materials used, such that the total weight of three secured blades (regulating, helical and maintaining) is distributed homogenously around the bulb.

Thus, the first group of secured blades is formed by at least six blades.

Each outer helical blade 42 is fastened, near its ends 42a, 42b, respectively, to the apices 40b and 41b of an outer regulating blade 40 and an outer maintaining blade 41. A secured assembly is thus formed by a helical blade, a regulating blade and a maintaining blade. The first group of secured blades therefore comprises at least two secured assemblies. However, for greater clarity, the figures in general only illustrate one of these assemblies. The blades of the first group are all arranged on the bulb 2 to rotate in a same first direction.

The turbine 1 according to the invention is further provided for a second group of secured blades comprising:
at least two inner regulating blades 50 developed essentially perpendicular to the surface of the bulb 2 and the bases 50a of which are situated close to the front end 2a of the bulb 2;
at least two inner maintaining blades 51 developed essentially perpendicular to the bulb 2 and situated approximately at mid-length of the bulb 2; and
at least two inner helical blades 52 each forming approximately ¾ to ⅚ of a turn.

The second group of secured blades is formed by the same number of blades as the first group and is formed by at least six blades. Consequently, the turbine 1 according to the invention comprises at least 12 blades.

The blades of the second group are arranged similarly to the blades of the first group: each inner helical blade 52 is fastened, at its ends 52a, 52b, respectively, to the apices 50b and 51b of an inner regulating blade 50 and an inner maintaining blade 51. Said blades thus formed a secure assembly. The second group of secured blades therefore comprises at least two secure assemblies. However, for greater clarity, the figures in general only illustrate one of these assemblies. Lastly, the blades of the second group are all arranged on the bulb 2 to rotate in a same second direction, opposite the first.

As illustrated in FIG. 6, the blades of the second group are situated longitudinally and transversely inside and near the blades of the first group, which justifies the terminology of the inner blade for the second group and outer blade for the first group. Thus, the blades of the second group rotate inside the space delimited by the blades of the first group.

The blades of each of the first and second groups are arranged so that the weight of each secured assembly formed by a regulating blade, a maintaining blade and a helical blade (40, 41, 42 or 50, 51, 52) and the total weight of each of the first and second groups of blades are distributed homogenously around the hub 3 of the turbine 1. In particular and preferably, the first and second groups of blades have the same weight.

The first and second groups of blades are arranged to rotate freely (without driving a generator alternator) at approximately the same speed.

If the inner helical blades 52 are not longitudinally stable enough, if there is a risk of coming into contact with the outer helical blades 42 during changes in speed or direction of the current, said inner helical blades 52 are fastened at the apices of additional maintaining blades 53 (FIG. 4) developed essentially perpendicular to the bulb 2 between the inner regulating blades 50 and the inner maintaining blades 51.

The outer and inner maintaining blades 41, 51 are preferably situated approximately at mid-length of the bulb 2. The stronger the current is, the more they are situated downstream from that point. The stronger the current is, the greater the longitudinal incidence (relative to the current) of the helical blades decreases, and the more longilineal the spirals are. The faster the current is, the more the length/separation ratio relative to the bulb 2 of the inner and outer helical blades 42, 52 increases, the more the turbine 1, including the bulb 2, elongates, and the more the incidence of the helical blades decreases to avoid the appearance of the vortex and cavitation.

As illustrated in FIG. 8, behind the inner and outer maintaining blades 41, 51, the bulb 2 has a maximum diameter dm that is constant over a fraction x of its length. The stronger the current is, the more this fraction elongates toward the rear of the bulb 2 to maintain an equal distance, relative to the speed of the current, between the trailing edges of the outer maintaining blades, at their base, and the appearance of turbulences, from the decrease in the diameter of the bulb. This distance must be sufficient for the turbulences not to slow the surrounding stream upstream. Downstream from this fraction, the diameter of the bulb 2 decreases, negative incidences appear on its surface and increase more and more to reach an approximate maximum im of 15° near the rear end 2b of the bulb 2. The greater the speed of the current is, the more than maximum negative incidence of the surface of the bulb 2 decreases. In the vicinity of the rear end 2b of the bulb 2, its diameter decreases more and more sharply, and the shape of the bulb 2 then approaches that of a half-sphere. A ring 6 is found at the rear end 2b of the bulb 2.

The increase in the diameter of the bulb 2 is maximal at the front end 2a thereof, in front of the base 40a, 50a of the outer and inner regulating blades 40, 50, then decreases more and more going toward the rear, to be zero in the vicinity of and downstream from the outer maintaining blades 41, approximately at half of the length of the bulb 2 (FIGS. 4, 5, 7 and 8).

The shape of the bulb 2 of the turbine according to the invention is designed to generate minimal turbulences (vortex and drag) in the surrounding fluid. It is known that the elongated shape of the bulb 2 produces the drag effect and may accentuate the current around its periphery. Such advantages are for example described in WO 2010/033147. However, the bulb of this document causes significant and long drag, the maximum diameter of which downstream from the turbine is not much smaller than the maximum diameter of the bulb. This downstream drag substantially reduces the productivity of the turbine and a fortiori that of any turbines fixed in a chain, behind one another. With a turbine according to the invention, this drag is reduced, since it has been noted that with a bulb whereof the negative incidences im are below 15° in its rear part 2d, the flow is not disturbed and remains laminar (little or no vortex) with weak to medium currents.

Regarding accentuating the current at the periphery of the bulb 2, it has been noted that this is true, particularly around and near the front end of the bulb, where the incidence of the surface of the bulb relative to the current is maximal. The further away one goes, the more the incidences decrease, the more the surrounding flow becomes slower, to have a speed approximately equal to that of the overall flow at the maximum diameter of the bulb. Downstream from that point, in light of the appearance of the vortices, the average speed of the stream surrounding the bulb decreases, becoming lower and lower than that of the overall stream. For the turbine to be able to benefit from this advantage of the acceleration of the stream surrounding the bulb, it is necessary to move the transition point as far away as possible, the level where the vortices appear, downstream from the maximum diameter of the bulb. That is the case with a turbine 1 according to the invention provided with a bulb 2 as described above.

The outer regulating blades 40, the inner regulating blades 50, the outer maintaining blades 41 and the inner maintaining blades 51 are associated with a respective rotor placed inside the bulb 2. The front end or nose 2a of the bulb 2 comprises the rotor of the outer regulating blades 40. The rotor of the outer maintaining blades 41 is contained in a compartment 2e of the bulb 2. The nose 2a of the bulb 2 and said compartment 2e rotate with the first group of outer secured blades (FIG. 7). The median part 2c of the bulb 2 that is situated between the rotors of the inner regulating blades 50 and the inner maintaining blades 51 and that comprises said rotors rotates with the second group of inner blades. The rear compartment 2d of the bulb 2 that extends over approximately half of the total length of said bulb 2 behind the rotor of the outer maintaining blades 41 does not rotate: said rear compartment 2d of the bulb 2 is fastened to the hub 3.

Air is confined in four compartments of the bulb 2, three of which are movable: the nose 2a, the median part 2c and the compartment 2e of the rotor of the outer maintaining blades 41. The stationary compartment is the rear compartment 2d of the bulb 2. The total volume of air, at a given depth, provides neutral buoyancy to the turbine 1 and keeps a horizontal position. This volume depends on the weight of the turbine 1, that of the portion of the maintaining cable 100 and the electric cable 101 situated between the profiled mast 102 or 103 and the bulb 2, and the depth at which the turbine 1 and free maintaining cable portion 100 are located.

In the bulb 2, in front of or behind the maintaining blades 41, 51, is the machinery generating electricity (generator, alternator, regulator). The blades of the first and second groups of secured blades are arranged so that the blades of the first group (outer blades) rotate in a first direction generating the same force and rotating at approximately the same speed as the blades of the second group (inner blades) rotating in a second direction opposite the first when the first and second groups of blades rotate freely (without driving a generator or alternator). Thus, the transverse rotating force generated by a single group of blades is canceled out.

In front of the bulb 2, close to the front end 2a or nose of the bulb 2, the rotor and the axis of the outer regulating blades 40 are secured to the hub 3 preferably via at least two ball bearings placed in front of and behind said rotor. The respective rotors and the axis of the inner regulating blades 50 and inner maintaining blades 51 are secured to the hub 3 preferably via at least eight rolling bearings situated at the front and rear of each of the rotors. The rotor and the axis of the outer maintaining blades 41 are secured to the hub 3 preferably via at least two ball bearings situated in front of and behind said rotor.

In front of the bulb 2, the leading edge 40c, 50c of the inner and outer regulating blades 40, 50, close to their base 40a, 50a, forms an angle close to 90° with the tangent to the curve forming the nose 2a of the bulb 2.

At their apex 40b, the leading edge 40c of the outer regulating blades 40 is located at the height of the front end 2a of the bulb 2 (FIGS. 5 and 8). The regulating blades 40, 50 and the maintaining blades 41, 51 have a shape approaching that of a propeller vane. From their base 40a, 50a, 41a, 51a to their apex 40b, 50b, 41b, 51b , their incidence increases and the curvature of their profile decreases. At their apex 40b, 50b, 41b, 51b, their transverse incidence is equal to the longitudinal incidence of the spiral of a helical blade 42, 52 in those locations. From their base 40a, 50a to their apex 40b, 50b, the relative (transverse) incidence of the regulating blades 40, 50 (incidence of the regulating blades relative to the current when the turbine 1 operates optimally) goes from approximately 15° to 5°. The maintaining blades 41, 51 have a relative incidence that decreases from their base to their apex and that is in principle less than that of the regulating blades 40, 50. In the vicinity of and downstream from the apex 50b of the inner regulating blades 50 and in the vicinity of and upstream from the apex 51b of the inner maintaining blades 51, the helical blades 42, 52 have a relative longitudinal incidence of approximately 5°. At the regulating blades and maintaining blades, the longitudinal incidence of the helical blades is zero. The relative average incidences of all of the blades are equal to approximately 10°. The relative maximum incidence is in principle less than or equal to 50°. The given values of 5, 10 and 15° for the relative incidences of the blades are conventional and variable: they depend on the speed of the current surrounding the blades. The optimal incidences are those which are maximal without generating vortices, those with which the flows surrounding the blades (and the rear compartment 2d of the bulb 2) remain minor. When the turbine 1 reaches its optimal speed of rotation, the flows surrounding all of the blades are laminar. The turbine 1 has a maximum speed of rotation determined by the appearance of cavitation on the rear part of the convex side of the blades or, at a greater speed, when the cavitation become too significant.

To preserve the laminar surrounding streams, the stronger the current is, the more the relative incidences and curvatures of the profiles of the blades decrease.

As illustrated in FIG. 11 (for the outer regulating blades), the profile of the blades is as fine as allowed by the materials used. A shaft is located inside the blades, placed on the pressure and vacuum distributing axis, ensuring structural rigidity of the blade (for example, shaft 40d in the outer regulating blades 40 and shaft 41d in the outer maintaining blades 41 illustrated in FIG. 4). The convex side of all of the blades is regularly convex over the entire length of their profile. From the base 40a, 50a to the apex 40b, 50b of the regulating blades 40, 50 and from the base 41a, 51a to the apex 41b, 51b of the maintaining blades 41, 51, the concave portion of the concave side i decreases: from the front, it goes from approximately ¾ of the length of the cord of the profile to half of that length (FIG. 11 for the outer regulating blades 40, with 40e designating the convex side and 40i designating the concave side). The remaining rear portion is convex. The length of the chords c of all of the blades is constant.

If the strength of the structure of a set of secured blades (regulating, helical and maintaining) and the longitudinal stability of the helical blades 42, 52 require it, approximately from ⅔ to ¾ of their length (depending on their size) up to their apex, the regulating blades 40, 50 and maintaining blades 41, 51 and their shaft are lined (FIGS. 8, 9, 10 and 12). The diameter of the shaft and the section of the lined profiles are reduced and constant therein. The chord of the lined profiles is reduced. If the strength of the sets of secured blades requires it, the chord of the lined profiles increases more and more near their apex, with the exception of the front linings 150 of the inner regulating blades 50 and the front linings 141 of the outer maintaining blades 41. In front of the turbine 1, going toward the outside, the front linings 140 of the outer regulating blades 40 are curved on the front, the rear linings 250 of the inner regulating blades 50 are curved on the rear. The apex of the front linings 140 of the outer regulating blades 40 is fastened to the outer helical blades 42 at a small distance from the front end 42a thereof. The apex of the rear linings 250 of the inner regulating blades 50 is fastened to the inner helical blades 52 at the end 52a thereof.

Behind the turbine 1, going toward the outside, the front linings 151 of the inner maintaining blades 51 are curved on the front and the rear linings 241 of the outer maintaining blades 41 are curved on the rear. The apex of the rear linings 251 of the inner maintaining blades 51 is fastened to the rear end 52b of the inner helical blades 52. The apex of the rear linings 241 of the outer maintaining blades 41 is fastened at a relatively small distance from the rear end 42b of the outer helical blades 42.

In the vicinity of their apex up to that apex, along the trailing edge and aligned with profiles of the front linings 150 of the inner regulating blades 50 and the front linings 141 of the outer maintaining blades 41, if the start-up of the first and second groups of blades (outer and inner) requires it, semi-rigid wings 9 are fastened that are approximately V-shaped (FIGS. 8, 9 and 10).

To offset their shorter length and the lower forces to which they are subjected, the inner blades of the second group of blades have a slightly longer profile with a curvature slightly lower than that of the outer blades of the first group.

The leading edge of all of the blades, on the concave side, has an approximately null relative incidence when the turbine 1 reaches its optimal speed of rotation.

As illustrated in FIG. 13, the spirals described by the helical blades 42, 52 contract longitudinally downstream from the regulating blades 40, 50 over approximately ⅔ to ¾ of their length. Approximately 5° in front, downstream from and in the vicinity of the apex of the inner regulating blades, the relative longitudinal incidence increases to reach a maximum in principle of less than or equal to 15°. From ⅔ to ¾ of the length, the helical blades 42, 52 extend longitudinally to achieve a longitudinal relative incidence at the leading edge of the maintaining blades 41, 51 equal to the relative transverse incidence of said blades at their apex. The spirals of the outer helical blades 42 in principle continue to expand downstream from the trailing edge of the outer maintaining blades as far as their rear end 42b. Over that portion, they have a propulsive action on the vortex and decrease the thickness of the limit layer (volume of the stream slightly disturbed situated between the non-disturbed and disturbed flows). The average relative longitudinal incidence of the spirals is approximately equal to 10°.

The average longitudinal incidence of the spirals, the length of the turns and that of the turbine 1 depend on the speed of the current. The stronger it is, the more the length/width ratio of a turn increases.

In front view (FIG. 6) and planar or profile view (FIG. 13), the spirals of the helical blades 42, 52, downstream from the apex of the inner regulating blades 50, are centripetal up to approximately ⅔ to ¾ behind their length. Past that point, the spirals of the helical blades 42, 52 are centrifugal, to be regular in the vicinity of and upstream from the inner maintaining blades 51.

The front end 42a of the outer helical blades 42 is slightly upstream from the front end 2a of the bulb 2 (FIGS. 5 and 8). From there end 42a at the trailing edge of the inner regulating blades 50, the outer helical blades 42 have no transverse or longitudinal incidences (FIG. 12). Their role is to separate the inner flow situated around and in the vicinity of the end of the outer regulating blades 40 and the outer flow and to increase the performance of those outer regulating blades 40 near their apex 40b. The apices of the inner 50 and outer 40 regulating blades, irrespective of whether they are aligned, are fastened to the inner helical blades 52, outer helical blades 42, respectively. In these locations, the concave side of the lined or unlined regulating blades 40, 50 is transversely slightly downstream from the leading edge of the helical blades 42, 54. In these locations, the trailing edge of the helical blades 42, 52 is further away, in the downstream direction, transversely, from the convex side of the regulating blades 40, 50, irrespective of whether they are aligned.

From their front end 42a as far as the leading edge of the front linings 140 of the outer regulating blades 40, the length and thickness of the profiles of the outer helical blades 42 increase sharply, then less and less (the trailing edge describes the decreasing curve and their leading edge is approximately rectilinear), then their chord and thickness are the same up to the vicinity of their rear end 42b (FIG. 9). From their front end to a point slightly upstream from the leading edge of the front linings 140 of the outer regulating blades 40, the profile of the outer helical blades 42 is symmetrical. From this point to downstream from and in the vicinity of the trailing edge of the rear linings 240 of the outer regulating blades 40, the outer helical blades 42 have an inner convex side. Downstream from that fraction, over a short distance, their convex and concave sides reverse. Their convex side is outside until the vicinity of and upstream from the leading edge of the front linings 241 of the outer maintaining blades 41 (FIG. 9). In that location, the convex side and the concave side of the outer helical blades 42 reverse again. There concave side is inside until the vicinity of an downstream from the trailing edge of the rear linings 241 of the outer maintaining blades 41.

From this point as far as their rear end 42b, the outer helical blades 42 have a symmetrical profile. Near their rear end 42b, the outer helical blades 42 have a profile whereof the length and thickness decrease sharply. Their shape approaches that of a half-disc there.

The front end 52a of the inner helical blades 52 has approximately the same shape as the front end 42a of the outer helical blades 42: the trailing edge describes a decreasing curve approaching the shape of a quarter-circle. The rear end 52b of the inner helical blades 52 has a shape symmetrically opposite that of the front end 42a of the outer helical blades 42: the trailing edge of said inner helical blades 52 describes an increasing curve there close to the shape of a quarter-circle.

The apices of the lined inner maintaining blades 51 are fastened to the inner helical blades 52. In these locations, the leading edges of the inner helical blades 52 are located transversely slightly upstream from the concave side of the linings of the lined inner regulating blades 51 and their trailing edge more sharply downstream from the convex side thereof. The convex side of the inner helical blades 52 is inside over their entire length, as far as their rear end 52b situated at the trailing edge of the rear linings 251 of the inner maintaining blades 51.

In front, in the vicinity of and downstream from the trailing edge of the rear linings 250 of the inner regulating blades 50, the inner helical blades 52 and outer helical blades 42 have a transverse incidence and a curvature of the profile in opposite directions that increase quickly to reach a relative transverse incidence close to 5°, then that increase is less and less sustained until approximately ⅔ to ¾ behind their length, in which location their relative incidence reaches a maximum in principle less than or equal to 15°. The relative transverse incidence decreases from that point to be zero in the vicinity of and upstream from the front linings 151 of the inner maintaining blades 51. The average relative transverse incidence of the inner and outer helical blades approaches 10°.

In order for the following description to be clearer, let us assume non-centripetal spirals: the trailing edges of the helical blades 42, 52 rest on the same circles over their entire length. The leading edge of the outer helical blades 42, downstream from the trailing edge of the rear linings 250 of the inner regulating blades 50, move away from the hub 3, to approximately ⅔ to ¾ behind their length (the incidence of the blades is increasing), then again approaches it from that point until the vicinity of, upstream from the front linings 151 of the inner maintaining blades 51 (if the incidence decreases). The transverse incidence of the outer helical blades 42 is zero in the vicinity of and upstream from the leading edge of the front linings 151 of the inner maintaining blades 51.

Conversely, the leading edge of the inner helical blades 52 approaches the hub 3 from the proximity of the trailing edge of the rear linings 250 of the inner regulating blades 50 up to approximately ⅔ to ¾ behind their length (the incidence of the blades is increasing, opposite that of the outer blades), then moves away from the hub 3 from that point, until coming into the vicinity of, upstream from the leading edge of the front linings 151 of the inner maintaining blades 51 (the incidence decreases), where it is found with the trailing edge, on the same initial circle (zero incidence).

When the turbine 1 is operating, the more the incidences (transverse and longitudinal) of the blades of two groups are opposed, the blades secured to the first group, called outer blades, generate a vortex, along their trailing edge, the direction of rotation of which is opposite that of the vortex generated by the blades of the second group of secured blades, called inner blades. At each intersection of an outer blade with an inner blade, over their entire length, the vortices counter one another and largely destroy one another. The vortices that can be observed downstream from the rear end of the helical blades 42, 52 and downstream from the inner regulating blades 50 and outer maintaining blades 41 are in fact substantially reduced.

The turbine described above in reference to FIGS. 4 to 13 has blades and a bulb that are dimensioned for weak to medium currents.

A second embodiment of the turbine according to the invention and sized for strong currents (from approximately 2 m/s) will now be described in detail in reference to FIGS. 14 and 15 in particular. The blades designed for weak and medium currents and those for strong currents having many similar features, the description below does not describe those features in detail. In particular, in this second embodiment, the same references designate the same parts or elements of the turbine. The turbine 1 sized for strong currents is provided with a first group of secured blades comprising at least two outer helical blades 42 each forming approximately ¾ to ⅚ of a turn and at least two outer maintaining blades 41 situated approximately at ⅔ of the length of the bulb 2 and developed essentially perpendicular to the bulb 2. Thus, the first group of secured blades is made up of at least four blades. Each outer helical blade 42 is fastened at its front end 42a near the front end 2a of the bulb 2 and not far from its rear end 42b at the apex 41 b of an outer maintaining blade 41. A secured assembly is thus formed by a helical blade and a maintaining blade. The first group of secured blades therefore comprises at least two secured assemblies. However, for greater clarity, FIG. 14 only illustrates one of these assembles. The blades of the first group are all arranged on the bulb 2 to rotate in a same first direction.

The turbine 1 sized for strong currents is provided with a second group of secured blades comprising at least two inner helical blades 52 each forming approximately ¾ to ⅚ of a turn and at least two inner maintaining blades 51 situated at approximately ⅔ of the length of the bulb 2 and developed essentially perpendicular to the bulb 2. Thus, the second group of secured blades is formed by at least four blades and consequently, the turbine according to the invention for strong current is made up of at least eight blades.

Each inner helical blade 52 is fastened at its front end 52a near the front end 2a of the bulb 2 and at its rear end 52b at the apex 51b of an inner maintaining blade 51. A secured assembly is thus formed by a helical blade and a maintaining blade. The second group of secured blades therefore comprises at least two secured assemblies. The blades of the second group are all arranged on the bulb 2 to rotate in a same second direction opposite the first.

The weight of a pair of helical and maintaining blades and that of each of the first and second groups of blades are distributed homogenously around the hub 3. The first and second groups of blades rotating in the opposite direction have approximately the same weight. The first and second groups rotate at approximately the same speed when they do not drive the generator or the alternator.

The faster the current is, the more the length/separation ratio of the helical blades 42, 52 relative to the surface of the bulb increases, and the more the turbine, including the bulb 2, elongates.

The front part or nose 2a of the bulb comprising the rotor of the outer helical blades 42 and the compartment 2e of the bulb 2 comprising the rotor of the outer maintaining blades 41 rotate with the outer blades forming the first group of blades. The median part 2c of the bulb situated between the rotor of the inner helical blades 52 and that of the inner maintaining blades 51 and comprising said rotors rotates with the inner blades forming the second group of secured blades. The rear compartment 2d of the bulb 2 (approximately ⅓ of its length in this embodiment), behind the rotor of the outer maintaining blades 41, does not rotate: said rear compartment 2d is fastened to the hub 3 of the bulb 2.

One of the elements that must be adapted for the turbine according to the invention to be able to be used in strong currents is the shape of the bulb 2. According to the second embodiment for strong currents, the positive incidences around the nose 2a of the bulb 2 are lower than those of the nose 2a of the bulb 2 configured for weak to medium currents. Downstream from and in the vicinity of the maintaining blades 41, 51, the bulb 2 of a turbine according to said second embodiment for strong currents has a maximum diameter dm that is constant over a fraction x of its length. The more the speed of the current increases, the more that fraction elongates. Downstream from that fraction x, negative incidences appear and increase on the surface of the bulb 2 to reach an approximate maximum I'm of 5° in the vicinity of the rear end 2b of the bulb 2. From that point, the diameter of the bulb 2 decreases sharply. That section of the bulb 2 approaches the shape of a half-sphere (FIG. 14).

In front, the outer helical blades 42 are secured to the hub 3 preferably via at least two ball bearings situated in front of and behind the rotor of said blades. The inner helical blades 52 are secured to the hub 3 of the bulb 2 preferably via at least four ball bearings situated at the front and rear of the rotor of said inner helical blades 52. The inner maintaining blades 51 are secured to the hub 3 preferably via at least four ball bearings situated in front of and behind the rotors of those blades and the outer maintaining blades 41 preferably via at least two ball bearings, situated in front of and behind rotors of said outer maintaining blades.

In front, in profile view, the leading edge of the helical blades 42, 52, near their base 42a, 52a, forms an angle of approximately 90° with the tangent to the curve forming the nose 2a of the bulb 2 (FIG. 14). From their base 42a, 52a to a point approximately close to their maximum separation, the helical blades 42, 52 are curved toward the front. The point furthest upstream from the rounded portion is situated approximately ¾ outside the maximum separation of the helical blades relative to the bulb (it depends on the size of blades). Regarding the outer helical blades 52, it is located at the height of the front end 2a of the bulb 2.

In front, in profile view (FIG. 16), from approximately the outer ¾ of the maximum separation of the helical blades (depending on their size), their curvature becomes more pronounced toward the rear, then decreases before the helical blades reach their maximum separation.

Seen from the front (FIG. 15), the helical blades 42, 52 describe a curve opposite their direction of rotation. Appearing near their base, this curve increases more and more, becomes more pronounced at approximately the outer ¾ of the maximum separation of the blades (depending on the size of the blades), to then decrease and form a circle at the maximum separation of the helical blades 42, 52.

In front, the incidence of the helical blades 42, 52 increases, their relative incidence and curvature decrease from their base 42a, 52a to the point where they reach their maximum separation. In front of the turbine 1, from the point furthest upstream reached by the helical blades 42, 52 up to their maximum separation, the helical blades 42, 52 go from a development in a plane substantially perpendicular to the current to a development in a plane essentially parallel to the current. Between these two points, the transverse and longitudinal incidences become intertwined. They can be added together once modulated by coefficients that evolve over the entire segment. In the vicinity of the maximum separation, the helical blades 42, 52 are oriented in the same plane as the current, they have begun their spiral, and the leading and trailing edges have reversed. At the point where they reach their maximum separation, the outer helical blades 42 have a zero transverse incidence. The relative longitudinal incidence is approximately equal to 5°.

At the point where the inner helical blades 52 reach their maximum separation, their relative transverse incidence is 5°, i.e., their relative transverse incidence, in front of the turbine, in the vertical, then horizontal plane, is never less than approximately 5°, so as to compensate their shorter length and the lower forces to which they are subjected, relative to the outer helical blades 42. At that point, the relative longitudinal incidence of the inner helical blades 52 is approximately 5°. The chords of all of the blades are constant.

In front, along the trailing edge and aligned with the profiles of the inner helical blades 52, approximately around points where they are situated furthest upstream (¾ of the maximum separation, depending on their size), if they are necessary to start the group of inner blades, semi-rigid wings 10 that are approximately D-shaped are fastened.

From a point not very far from the apex of the outer maintaining blades 42 to that apex, along the trailing edge and aligned with their profile, if they prove necessary to start up the group of outer blades, semi-rigid wings 9, approximately V-shaped, are fastened. The first and second groups of blades (inner and outer) rotate at approximately the same speed when they do not drive the generator or the alternator.

The spirals described by the helical blades 42, 52 contract longitudinally from their maximum separation, approximately up to ⅔ to ¾ of the length of their spiral taken from their maximum separation relative to the bulb 2. From that point, the spirals expand to reach, at the leading edges of the apices of the maintaining blades 41, 51, a longitudinal relative incidence equal to the transverse relative incidence of said maintaining blades in those locations. The spirals of the outer helical blades 42 in principle continue to expand downstream from the apex 41b of the outer maintaining blades 41 to their end 42b and have a propulsive action.

Seen from the front, in front, the spirals of the helical blades 42, 52, from their maximum separation, follow centripetal curves up to approximately ⅔ to ¾ of their length (taken from the maximum separation of the blades). From that point, the curves of the spirals are centrifugal, to be regular upstream from and in the vicinity of the apices 51b of the inner maintaining blades 51.

The outer helical blades 42, from their maximum separation in the vicinity of and upstream from the leading edge of the inner maintaining blades 51, have an outer convex side. Around that point, their convex side goes from the outside to the inside up to the vicinity of and downstream from the trailing edge of the outer maintaining blades 41. Downstream from that level to their rear end, the outer helical blades 42 have a symmetrical profile whose length decreases sharply in the vicinity of the rear end 42b, which has a shape approaching that of a half-disc.

The convex side of the inner helical blades 52 is located on the inside over their entire length.

In front, downstream from their maximum separation, the outer helical blades 52 have a profile curvature and a transverse incidence that quickly intersect to reach a relative incidence of 5°, then that increase is less and less sustained up to approximately ⅔ to ¾ of the length of their spiral (taken from the maximum separation of the blades), where their relative incidence reaches approximately 15° maximum. The transverse incidence and the curvature of their profile decrease from that point to disappear in the vicinity of and upstream from the inner maintaining blades 51. At their maximum separation, the inner helical blades 52 have a relative transverse incidence of 5°. Downstream from that point, their relative transverse incidence and the curvature of their profile increase, less and less, to reach a maximum of 15° at a point situated approximately between ⅔ and ¾ of the length of their spiral taken from the maximum separation of the blades. Their incidence and the curvature of their profile decrease from that point to disappear in the vicinity of and upstream from the leading edge of the inner maintaining blades 51.

Let us assume non-centripetal spirals: the trailing edges of the helical blades 42, 52 rest on the same circles (inner and outer) over their entire length. The leading edge of the outer helical blades 42 downstream from their maximum separation moves away from the hub 3 up to a point situated approximately between ⅔ and ¾ of the length of the spirals of the blades considered from their maximum separation (the incidence of the blades is increasing), then again comes closer (their incidence decreases) to the vicinity of and upstream from the inner maintaining blades 51. At that level, the incidence of the outer helical blades 42 once again becomes zero.

Conversely, the leading edge of the inner helical blades 52 approaches the hub 3 from their maximum separation to a point situated approximately between ⅔ and ¾ of the length of the spirals of the blades (increasing incidence), then moves away from it (decreasing incidence), up to the vicinity of and upstream from the inner maintaining blades 51, where it is found with the trailing edge on the same initial circle (zero incidence).

In general, according to the invention, the turbine designed for strong currents therefore comprises a bulb on which the first and second groups of blades are fastened. The first and second groups each comprise at least two helical blades extending, on the front, essentially and approximately perpendicular to the bulb and over the rest of their length essentially and approximately parallel to the bulb, and as many maintaining blades extending essentially perpendicular to the bulb, situated between half and ⅔ of the length of said bulb, the helical blades being fastened at a first end to the front end of the bulb, while their second end is fastened to a maintaining blade. The first group and the second group of blades are arranged to rotate in opposite directions, the second rotating in the space delimited by the blades of the first group.

According to the invention, the transverse and longitudinal incidences of the helical blades, once modulated by coefficients that evolve over the entire length of those blades, can be added to obtain the total force obtained. This force, according to the invention, is greater than that obtained with blades in a similar situation opposing an incidence twice as great, only transverse to the current, because the flows around the helical blades are laminar.

According to the invention, it is the addition of the increase of the diameter of the bulb (slight increase of the speed of the stream at the height of the helical blades) and the concentricity of the helical blades toward the rear that is efficient. The space between the bulb and the helical blades decreases more and more, going toward the rear, then less and less (from ⅔ to ¾ of the length of the helical blades taken from the maximum separation), to be constant upstream from and in the vicinity of the maintaining blades. It is similar to that of a reactor piping.

The concentricity of the inner helical blades allows them to operate in a stream that is only slightly disturbed by the regulating blades. The role of the concentricity of the helical blades is also to concentrate the vortices appearing along the trailing edge, therefore to reduce the diameter of the disturbed stream and the volume of fluid slowed downstream from the turbine.

The speed of rotation of the turbine according to the invention is proportional to the speed of the current, but it is never very high. The blades are preferably made from steel and most of the weight of the sets of blades is found not far from the maximum separation of the letter relative to the hub.

In general, the helical blades of the turbine develop over half to ⅔ of the length of the bulb and the maximum diameter of the bulb is between its half-length and ⅔ behind the length thereof.

The turbine according to the invention also has the advantage of being able to be placed in series on a same site. In fact, the turbine according to the invention being configured to limit the turbulences created by its operation, it does not bother a similar turbine placed nearby.

Alternatively, depending on the force of the current, the helical blades can be fastened to the bulb via regulating blades extending essentially perpendicular to the surface of the bulb at the front end of said bulb.

1. A turbine for generating electricity from a fluid current, comprising:
a central bulb;
first and second groups of blades each mounted on the bulb;
the first group of blades being arranged to rotate in a first direction under the action of the fluid current, and the second group of blades being arranged to rotate in a second direction opposite the first direction under the action of the fluid current,
the blades of said second group also being arranged to rotate in the space delimited by the blades of the first group;
wherein the first and second groups of blades each comprise at least two helical blades and at least two maintaining blades;
in that in each of the first and second groups, the number of helical blades is equal to the number of maintaining blades;
in that the bases of the maintaining blades are fastened to the bulb and extend essentially perpendicularly relative to the bulk; and
in that each helical blade is fastened at a first end to the front end of the bulb and at or near a second end to the apex of a maintaining blade.

2. The turbine according to claim 1, wherein
the first and second groups of blades further each comprise at least two regulating blades the number of regulating blades being equal to the number of helical blades;
in that said regulating blades are developed essentially perpendicular to the surface of the bulb and their bases are situated near the front end of the bulb and
in that each helical blade is fastened at or near its first end to the apex of a regulating blade,
each helical blade therefore being fastened at a first end to the front end of the bulb by means of said regulating blades.

3. The turbine according to claim 1, wherein
the bulb a has a maximum diameter (dm) that is constant over a fraction (x) of its length situated behind the maintaining blades,
the diameter of the bulb decreasing regularly downstream from that fraction (x) and
negative incidences appearing on the surface of the bulb increase more and more to reach an approximate maximum near the rear end of the bulb,
the diameter of the bulb decreasing more and more near the rear end of the bulb,
the shape of the bulb a approaching that of a half-sphere.

4. The turbine according to claim 3, where
the approximate maximum (im, i'm) of the negative incidences of the bulb is comprised between 5 and 15 degrees.

5. The turbine according to claim 1, wherein
the second group of blades further comprises as many additional maintaining blades as there are helical blades,
said additional maintaining blades extending essentially perpendicular to the bulb and being fastened at their base to said bulb between the front end of said bulb and the base of a maintaining blade, and at their apex to a helical blade of said second group of blades.

6. The turbine according to claim 1, wherein
the bulb has at least one compartment designed to receive the electrical apparatuses necessary to produce electricity.

7. The turbine according to claim 1, wherein
the bulb has zones filled with air distributed over its length to ensure the neutrality of the buoyancy and the horizontal positioning of the turbine once submerged.

8. The turbine according to claim 1, wherein
the helical blades of the first and second groups of blades each form between ¾ and ⅚ of a turn.

9. The turbine according to claim 8, wherein
the spirals formed by the helical blades are centripetal downstream from the front end of the bulb up to ⅔ to ¾ of the length of said helical blades taken from their maximum separation with respect to the bulb,
the spirals being centrifugal from that point to be regular at the rear end of said helical blades.

10. The turbine according to claim 1, wherein
the maintaining blades are split from ⅔ to ¾ of their length from the bulb.

11. The turbine according to claim 2, wherein
the regulating blades are split from ⅔ to ¾ of their length from the bulb.

12. The turbine according to claim 1, wherein
a semi-rigid wing is fastened on each of the maintaining blades of the first group of blades, the wing being designed to facilitate the start-up of the rotation of said first group of blades.

13. The turbine according to claim 2, wherein
a semi-rigid wing is fastened on each of the regulating blades of the second group of blades, the wing being designed to facilitate the start-up of the rotation of said second group of blades.

14. The turbine according to claim 1, wherein
a semi-rigid wing is fastened on each of the helical blades of the second group of blades, the wing being designed to facilitate the start-up of the rotation of said second group of blades.
